(19) United States
(12) Patent Application Publication
(10) Pub. No.: US 2005/0060390 A1
(43) Pub. Date: Mar. 17, 2005

(54) Method and system for plug and play installation of network entities in a mobile wireless internet

(76) Inventors: Faramak Vakil, Bedminster, NJ (US); Byungsuk Kim, Edgewater, NJ (US); Sunil Madhani, Morristown, NJ (US); Eric Van Den Berg, Hoboken, NJ (US); Shinichi Baba, Irvine, CA (US)

Correspondence Address: Telcordia Technologies, Inc., One Telcordia Drive 5G116, Piscataway, NJ, 08854-4157, US

(21) Appl. No.: 10/662,893

(22) Filed: Sep. 15, 2003

(51) Int. Cl. G06F 15/177

(52) U.S. Cl. 709/220

(57) ABSTRACT

A system and method are provided for adding network entities and appliances to a mobile wireless Internet. A graphical user interface on a user appliance or network entity is used to start a plug and play process. In the plug and play process a temporary IP address is assigned to the entity or appliance. The temporary address is tested for uniqueness. A search mechanism identifies and contacts a plug server that uses information from the user/operator to authenticate the user and/or validate subscription information. Upon authentication or validation the plug server dispatches an inspector agent to determine the software needs of the new entity or appliance. The plug server obtains the requested software from the software inventory and the inspector agent downloads the software onto the new entity or appliance and installs it therein. The element then uses the DRCP/DHCP client to obtain a new IP address. Link layer and topology information are selected and downloaded to the entity or appliance and the unit is plugged into the network for mobile wireless Internet access.

### FIELD OF THE INVENTION

The present invention relates to mobile telecommunications networks and, in particular, to methods and systems for activating new network entities and appliances in a mobile wireless Internet with minimal or no human intervention.

### BACKGROUND

In mobile telecommunications networks the current prevalent practice for expanding the network and service infrastructure or the subscriber base involves significant human interaction with the network and significant human operator assistance. For instance, proper activation of new network entities and appliances (e.g., routers, servers, user hosts and appliances, etc.) requires involvement of expert human operators with significant networking and software troubleshooting knowledge after the installation of the necessary hardware. Such a manual process is time-consuming, tedious, prone to errors, and expensive. The automation of these network and service management tasks is quite desirable because it reduces chances of human error, improves network services, reduces operation, administration, maintenance and provisioning (OAM&P) costs, and enhances network providers' competitiveness and profit.

The global wireless and wireline communication infrastructure plays a critical role in present world. In order to manage this infrastructure, network operators and service providers usually maintain large workforces and invest large sums of money in OAM&P systems to ensure the proper operation of their communication infrastructure in order to satisfy consumer demand. Furthermore, network operators rely on OAM&P systems to deploy appropriate business policies to enhance their competitiveness and profitability in the marketplace.

In the last several years, the home networking industry has developed a standard called Universal Plug and Play (UPnP). UPnP is a plug and play technology developed for the home networking environment. UPnP provides an interactive approach that relies heavily on the user's interaction with the network and is primarily tailored to ad-hoc home networks. UPnP assumes that the users have a-priori knowledge of their appliances' (or entities') needs and interact with the network to obtain them. It requires too much user interaction, is inconvenient for typical users, and too prone to their errors to work in the mobile Internet environment.

Therefore, it is an object of this invention to provide a method and system to add and activate network elements, such as routers, base transceiver stations (BTS) and servers, with minimal or no human intervention.

Furthermore, it is an object of the present invention to permit subscribers of mobile telecommunications networks, such as cellular phone or other wireless networks to install and activate their wireless appliances with the same ease as landline telephones are currently installed.

Additionally, it is an object of the present invention to allow mobile wireless Internet operators to add new network entities to their infrastructures and permits users to activate their wireless appliances and services automatically with minimal (if any) human assistance thereby reducing OAM&P costs and promoting user convenience.

### SUMMARY

The primary requirements of a plug and play process in wireless networks, as in wireline networks, are security, reliability, automation and reasonable signaling overhead. In general, plug and play is not a real-time process, though it is possible that a mobile user could roam across administrative domains before completion of an ongoing plug and play process. Thus, in a mobile wireless Internet, the plug and play process has stringent real-time response requirements in case of user appliances so mobile users can plug and activate their appliances even if such users are not stationary during the process without disrupting the user's ongoing service.

The plug and play process and system of the present invention enables any entity to join the network but also protects the network against malicious users or entities. The process and system scans new incoming entities to ensure they are virus free and do not pose a threat to the networks operation. Additionally, the process and system provide means of mutual authentication between the user and the plug and play server without compromising their security credentials. Furthermore, the process and system guarantees the privacy of the necessary communications particularly on wireless links.

The plug and play process and system must be reliable and accurate to avoid either network disruptions or user dissatisfactions and must be automated maximally to reduce the deployment time and cost as well as minimize the potential for human errors and increase its reliability.

Plug and play signaling overhead is not a critical factor for the network entities that are connected through the core part of the mobile wireless Internet. Wireless bandwidth is scarce, however, so the required signaling for the addition and activation of mobile terminals, also referred to as mobile stations, should be minimized. Any particular mobile station many not be quasi-stationary during the plug (addition or insertion) process. If so, the plug and play process may have a stringent delay requirement because the network knows nothing about this mobile station before completion of the plug and play process and the mobile station is unable to take advantage of the network's mobility features and services and the mobile station's connection with the plug server is lost.

A method and system is provided for enabling the connection of a new entity or appliance to a mobile wireless Internet for provision of services to a user of the entity. A temporary IP address is assigned to the new entity. The new entity searches for and communicates in a secure manner with a plug server that collects information on the user's identity and subscription and authenticates and validates such information. The plug server then uses an inspector agent to identify the software needed by the entity to provide the service. The plug server then collects the necessary software from one or more software inventories in which it is in communication. The software is then forwarded to the entity and installed by the inspector agent. The entity is then assigned a new “permanent” IP address and necessary topology and link layer data is collected by the plug server from the cell parameter server, and are downloaded to the entity by the inspector agent. The entity is connected or “plugged” into the mobile wireless Internet with minimal user interaction. The profile server for the network is updated to reflect the newly “plugged” entity.

In the present invention the plug server is the gateway between the entity or appliance and the software inventory, cell parameter server, AAA and credit bureau server.

The present invention also provides for the automated assignment of a temporary IP address to the entity through the use of an Auto-IP function for use in IPv4 networks.

At the initiation of the plug and play process the entity need only execute plug and play client software, which contains the Auto-IP, Server Discovery and PlugMe modules. All additional software necessary for a specific service is identified by the inspector agent, collected by the plug server, and downloaded from the plug server to the entity and installed by the inspector agent. The plug and play client also contains security policy profiles that grant the inspector agent required security permissions for installing the downloaded software on the entity in a secure manner.

The plug server includes three inventive software modules for performing the plug and play process: a selection handler, a subscription handler, a login handler and the inspector agent.

### BRIEF DESCRIPTION OF THE DRAWINGS

FIG. 1 depicts a first embodiment of the mobile wireless plug and play system in accordance the present invention.

FIGS. 2a and 2b depict the process flow for the plug and play process of the present invention.

FIG. 3 depicts the process flow for the Auto-IP process of the present invention.

FIGS. 4a and 4b depict the process flow of the plug process for a network entity of a current subscriber.

FIG. 5 depicts the software architecture of a plug and play client in accordance with the present invention.

FIG. 6 depicts the software architecture of a plug server in accordance with the present invention.

### DETAILED DESCRIPTION OF THE DRAWINGS

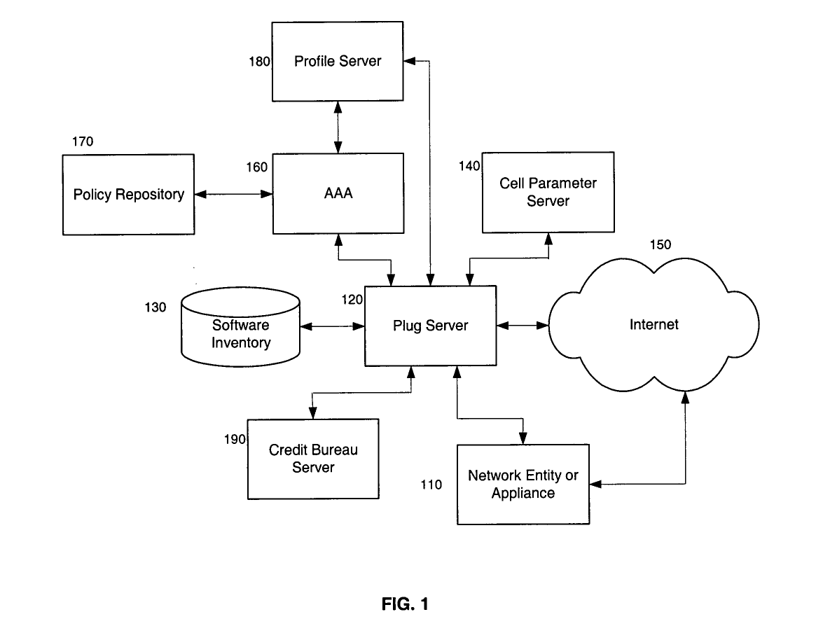

FIG. 1 depicts a mobile wireless plug and play system in accordance with the present invention. A network entity or appliance 110 is a server, router, user host or user appliances that forms or will form part of a mobile wireless Internet. The term entity and appliance as well as element may be used herein to refer to servers, routers, cell phones, wireless PDAs and other devices that operate in a mobile wireless network. Network entities and appliances 110 are preferably equipped with a TCP/IP protocol software suite, a Java Virtual Machine (JVM), a Java-enable HyperText Transfer Protocol (HTTP) browser, and the plug and play client software as specified in this invention. The present invention uses a web-based client server architecture relying on HTTP for communications between the client and the server.

The foundations of the proposed system architecture are plug server 120, software inventory 130 and a cell parameter server (i.e., a configuration server) 140. The plug server 120 is the focal point of contact between any new entity 110 and the network. Upon attachment to the Internet 150 through a mobile wireless connection, a new network entity or appliance 110 attempts to discover a plug server 120. Each plug server 120 uses the Java database connectivity (JDBC) application programming interface (API) to interact with the authentication, authorization and accounting (AAA) server 160 and/or credit bureau 190 to authenticate the user's identity and/or the user's credit. Upon successful authentication, the plug server 120 dispatches a software-implemented inspector agent, described below, to the new entity or appliance 110 in order to assess the software needs of that entity or appliance. The plug server 120 then interacts with the software inventory 130 and cell parameter server 140 to obtain the necessary configuration and software for the entity or appliance 110. Finally, the inspector agent downloads this software from plug server 120, and installs and configures the entity or appliance 110.

The software inventory 130 is the repository of all the network and service management software that is available to and accessible by the plug server 120. The software inventory comprises a distributed database on the worldwide web that has spread across the mobile wireless Internet. The exact architecture for realization of this database depends on the plug and play process delay requirements, operators' business constraints, costs, as well as regulatory policies. Using information on these factors it would become obvious for one skilled in the art to design the software inventory architecture.

In general, a network entity (or an appliance) 110 is likely to contain Dynamic Registration and Configuration Protocol (DRCP)/Dynamic Host Communication Protocol (DHCP). The DRCP/DHCP client is not necessary if IPv6 is used due to its stateless auto-configuration feature. However, to ensure a uniform plug and play process across both IPv4 and IPv6 networks, these is an Auto-IP process for IPv4 that utilizes router solicitation and advertisement messages to auto-configure IPv4 entities. The Auto-IP process is discussed in greater detail below.

The cell parameter server (or configuration server) 140 contains the topology information and layer two configurations of the wireless network and its cells such as frequency reuse plans. An off-line network planning and design bench, such as the Telcordia Network Engineer, periodically computes and updates network configuration information in accordance with the provider's network-wide policies and forward it to the cell parameter (i.e., configuration) server.

The policy repository 170 is used by the AAA 160 as the repository for all rules regarding authentication. The policy repository 170 is a database containing the rules that governs the access rights, usage, quality of service, security privileges etc. of subscribers and/or their services. The AAA server 160 is a collective responsible for verifying subscribers' identities (i.e., authentication), their privileges (i.e., authorizations), and their usages and means of charging and paying (i.e., accounting).

A profile server 180 is a server that provides information regarding the profile of the user to the AAA 160 and the plug server 120. The profile server 180 is a repository of subscriber, service, and terminal objects. Each subscriber has a subscriber object to define the basic service authorizations, one or more terminal objects to define the capabilities of various terminals that the subscriber normally uses and one or more service objects defining the services available to a subscriber.

The credit bureau server 190 is responsible for clearing requests for services with regard to funds available for a specific user with regard to specific requested services. The credit bureau server 190 is a repository of subscribers credit credentials such as their credit cards, their credit limits, billing addresses, etc.

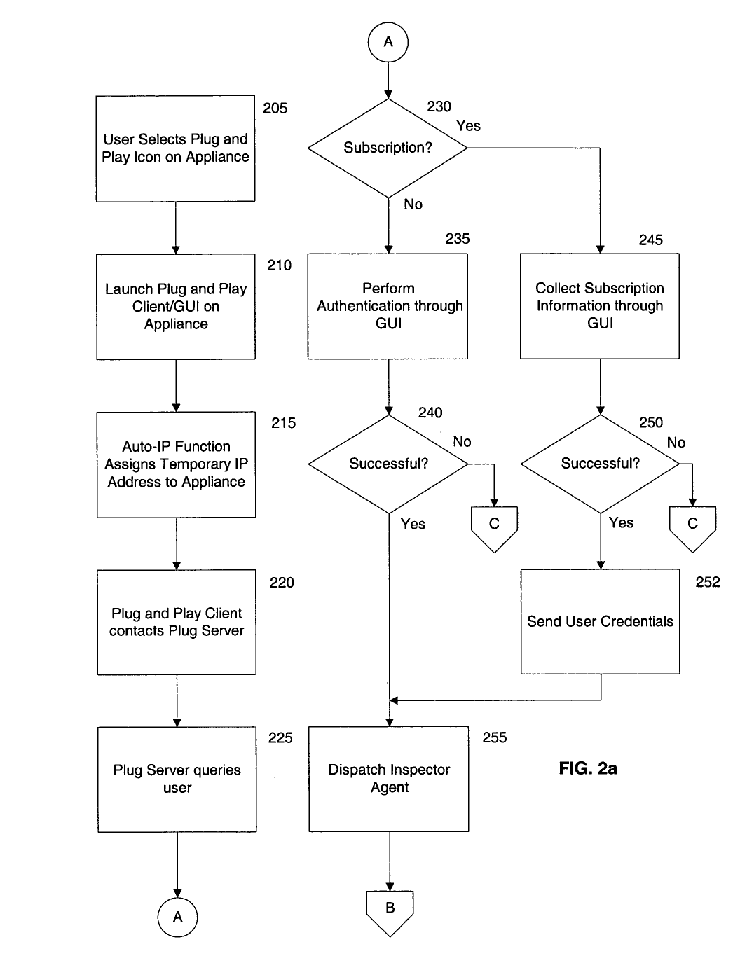

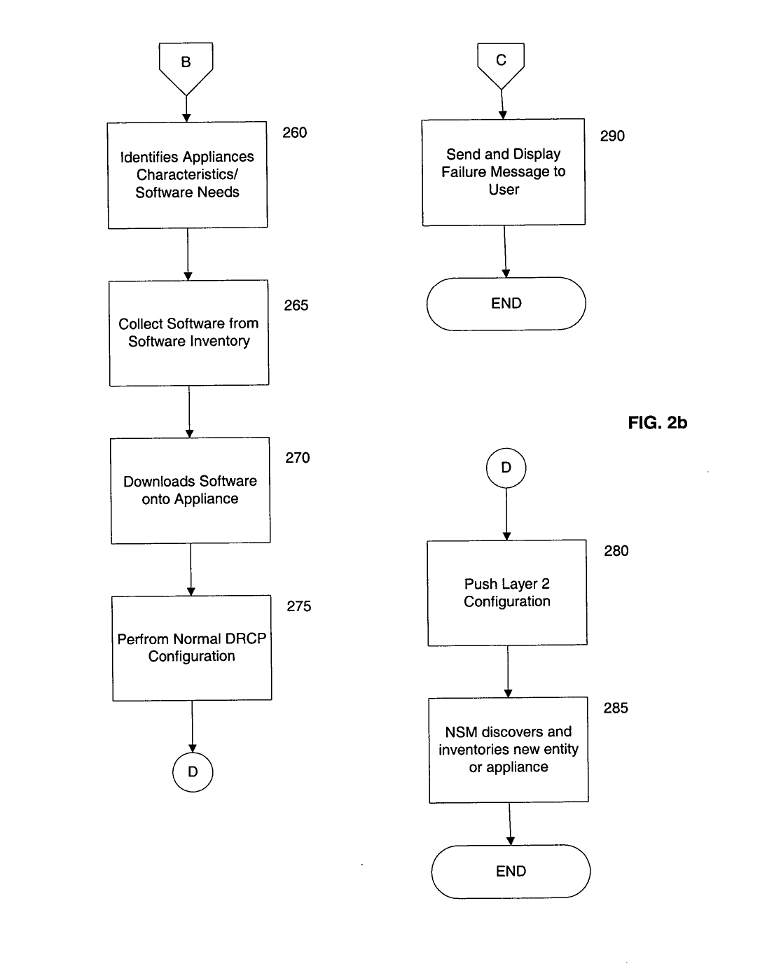

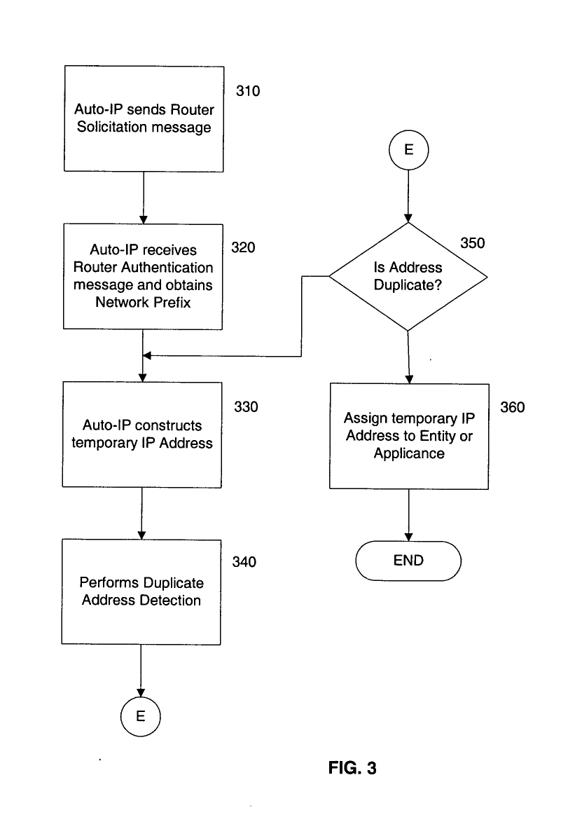

The process flow for the plug and play process is depicted in FIGS. 2a and 2b. In the method of the present invention, at step 205 the user of a new entity or appliance, either an operator or user/subscriber, clicks on the plug and play (P&P) icon on the network entity or appliance 110. At step 210, the plug and play client begins to execute, a GUI opens and the user selects the appropriate option to initiate the plug process. At step 215, the Auto-IP function of the plug and play client utilizes router solicitation and advertisement messages to assign a temporary and unique IP address to the appliance. The Auto-IP process is further defined below in connection with FIG. 3. The plug and play client subsequently seeks to find and contact a plug server at step 220. Upon its discovery and contact with the appliance or entity 110 after mutual authentication, the plug server queries the user of the appliance or entity to determine whether the user intends to subscribe to network service(s) or already has a valid subscription at step 225. Depending on the user's response either an authentication or subscription process takes place branching at step 230. If the user is requesting a service subscription, the plug and play client collects information about the user and his credit through the GUI at step 245. If the subscription is determined to be valid the newly assigned credentials of the user are sent to the entity (or appliance) at step 252. Alternatively, if the user does not require a subscription and already has a valid one, the plug server 120 authenticates the identity of the user through plug and play client and its GUI at step 235. If the authentication is successful the process continues on to step 255. If either authentication or subscription validation are not successful the user will receive an error message at step 290.

At step 255, the server dispatches an inspector agent, which in the preferred embodiment is a Java applet, onto the network element (entity or appliance) to identify what software it needs to provide the service. On behalf of the plug server 120, the inspector agent identifies the necessary software at step 260, retrieves (either by itself or in cooperation with the plug server) the necessary software from the software inventory 130 at step 265 and downloads the software into the entity or appliance 110 and installs the software in the entity at step 270. At step 275, after installation of the necessary software in the entity, the element/appliance utilizes the normal DRCP/DHCP procedure to configure itself with an address that is taken from the provider where the DRCP/DHCP server may re-assign the temporary address as its permanent one. The advantage of receiving an address from the provider's DRCP server is that it reduces the chance for the existence of duplicate addresses and ensures that the entity's address is unique.

The final step in the plug and play process is the downloading of all necessary link layer and topology configuration data into the element at step 280. Upon completion of step 285 the element or entity becomes an entity or appliance managed by the network and service management system (NSM).

FIG. 3 depicts the Auto-IP process that utilizes router solicitation and advertisement messages to assign a temporary unique IP address to the entity or appliance. At step 310, the Auto-IP routine sends a Router Solicitation message and listens for a Router Authentication messages to obtain the Network Prefix. At step 320, the Auto-IP routine constructs a temporary IP address comprising the Network Prefix plus a randomly chosen Host Suffix and then perform a Duplicate Address Detection (DAD) at step 330. If the Duplicate Address Detection (DAD) fails, i.e., if the chosen address is already in use as determined at step 350, the Auto-IP process returns to step 330 and another temporary IP address is constructed, otherwise the network element has its temporary and unique IP address for assignment at step 360.

The plug and play process and system of the present invention provides a mechanism for the unambiguous discovery of the plug server. Additionally, upon reception of the plug request from a plug client, the plug server asks the client to upgrade to secure HTTP (S-HTTP) so that subsequent interactions take place on a secure socket layer. The Java virtual machine (JVM) has a security policy management tool called “policytool” that provides code signing as well as permission assignment mechanisms. The JVM “policytool” can be utilized to ensure mutual plug server-client authentication as ell as grant read, write and execute permission to the inspector agent in the Java runtime environment of a Java enables browser as necessary. The inspector agent reads files on the element's disk to determine what is missing, obtains the necessary software from the software inventory and writes the software to the element's memory (whether disk or RAM) and executes all necessary commands to install the software properly. In principle, the JVM “policytool” enables the plug and play client to define a security policy file so that it interacts with the plug servers which can identify themselves with certificates that are recognized by the plug and play client. The JVM “policytool” grants certain permissions and rights to inspector agents (i.e., Java applets) that are signed with certificates of recognized network operators and/or service providers.

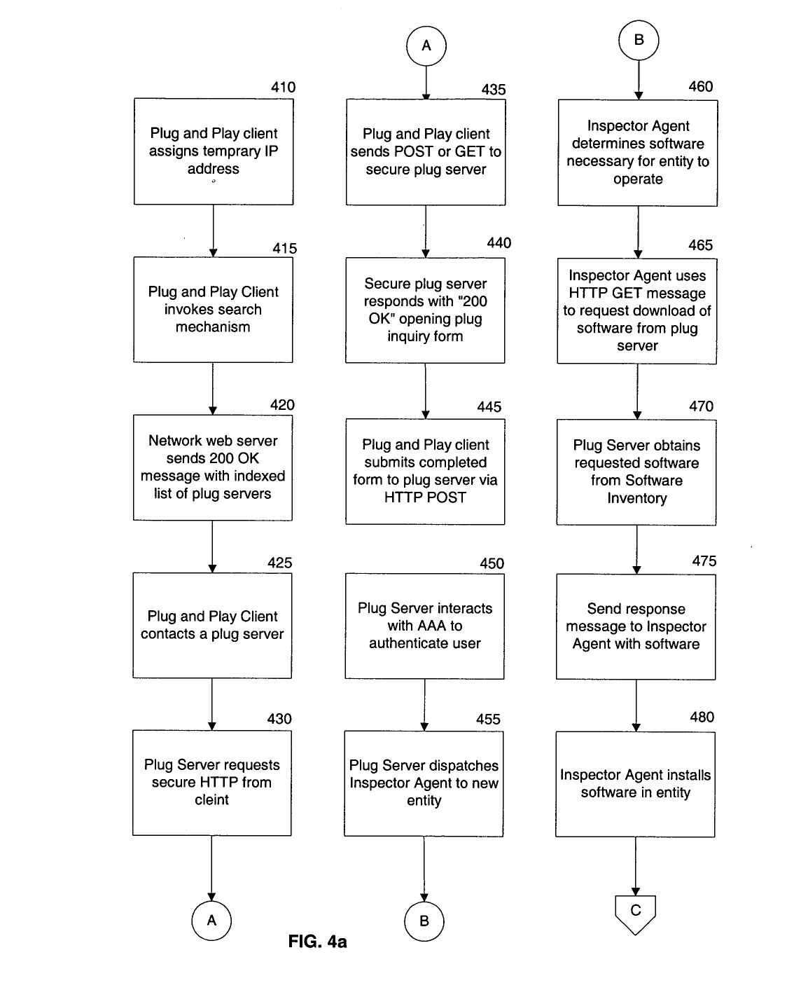

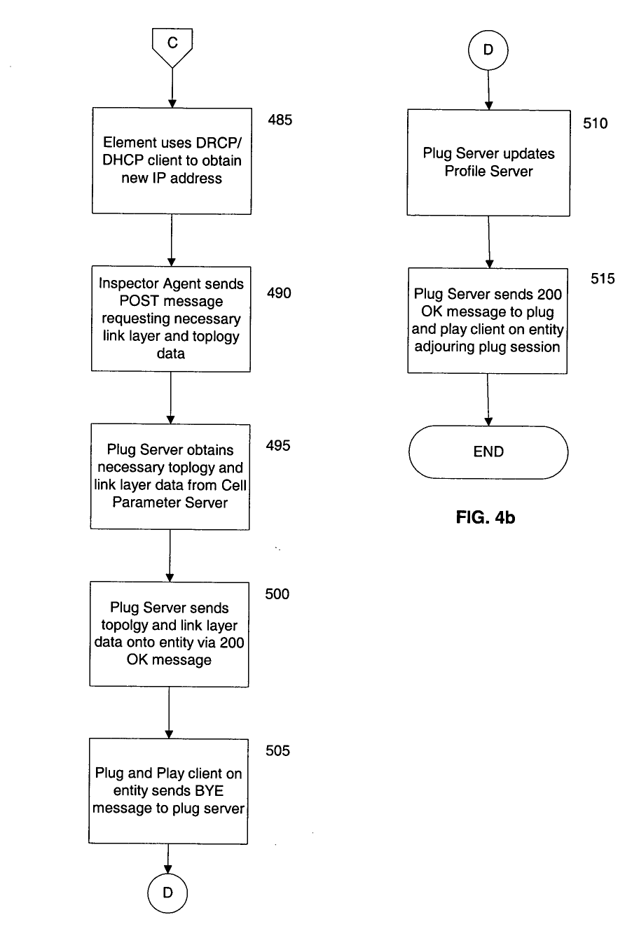

FIG. 4 shows the signaling flow of the plug process for a subscriber who has a current valid subscription. At step 410 of FIG. 4 the plug and play client assigns a temporary IP address using either its own Auto-IP scheme or the DRCP/DHCP of the entity or element. At step 415 the plug and play client invokes its search mechanism, to discover a plug server or set of plug servers on the network. At step 420, in response to this search request, a network web server sends a 200 OK message containing an indexed list of plug servers. At step 425, the plug and play client selects one of the plug servers on the list and contacts the selected plug server using the HTTP POST or GET message/method. At step 430, the plug process must be made secure so the plug server immediately sends an HTTP 101 (switching protocol) message containing the upgrade general header to inform the client that it has requested a secure HTTP page. The client-server communications take place on a secure connection thereafter.

At step 435, the plug and play client sends its POST or GET request to the secure plug server through a secure connection. At step 440, the secure plug server responds with a “200 OK” message opening a plug inquiry form asking about the client's subscription status. At step 445, the plug and play client submits the completed LOGIN form to the server via HTTP POST message. At step 450, the plug server interacts with the network AAA system to authenticate the user's credentials. Upon successful authentication of the user, the plug server dispatches an inspector agent at step 455 to determine the needs of the new element at step 460. The inspector agent utilizes HTTP GET messages to download necessary software from the plug server at step 465. At step 470, the plug server obtains the necessary software from the software inventory located at various servers across the network and packs if into a response message sent to the inspector agent at step 475. The plug server uses a 200 OK message to send all necessary network and service management (NSM) software and/or scripts such as SIP, SNMP, DRCP, etc. to the inspector agent. At step 480, the inspector agent installs the NSM software. The proper preparation of the NSM software package plays a key role in the realization of successful plug and play kit.

At step 485, the element uses its newly installed DRCP/DHCP client to perform a normal configuration and acquire a “permanent” address from the operator/provider. At step 490 the inspector on the P&P client sends a POST message to the plug server asking for the necessary link layer and the network topology data (e.g., a frequency plan for a TDMA BTS). At step 495, the plug server obtains the necessary topology and link layer data from the cell parameter server (i.e., network configuration server). At step 500, the plug server pushes the topology and link layer data onto the element via a 200 OK message. The plug is now complete. At step 505, the plug and play client sends a BYE message to the plug server. Upon reception of the BYE message, the plug server updates the profile server at step 510 to reflect the final profile of the now plugged element. At step 515, the plug server sends a 200 OK message to the plug and play client adjourning the plug session.

The present invention has been implemented in Java using HTML scripts to provide a web-based user interface. The plug and play server runs on an Apache-Tomcat-3.2.3 web server that provides an appropriate execution environment for running Java servlets and the client utilizes the Java enables web browser of the new element.

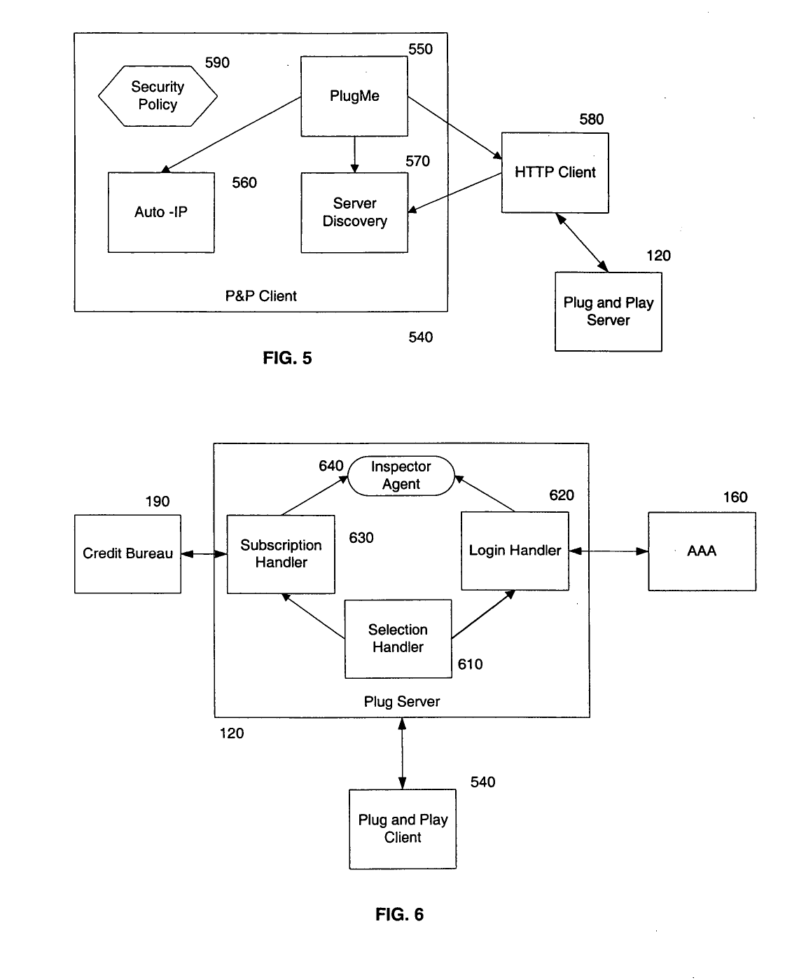

FIG. 5 depicts the software architecture of the plug and play client 540. PlugMe 550, Auto-IP 560 and Server Discovery 570 are the three objects comprising the plug and play client 540 that interact with an HTTP client (i.e., the appliance web browser) 580. Moreover, the plug and play client 540 also contains a security policy file 590 that allows the appliance to grant necessary permission to the inspector agent applets that are dispatched onto it by the plug server 120. The PlugMe object 550 written in the Java language is the main object and provides a simple graphical user interface (GUI) for the plug and play client. The PlugMe object allows a user to initiate the plug process and integrates the plug and play client security profile with the “.java.policy” file of the JVM on the appliance. The Auto-IP object 560 is written in the C programming language and is integrated in executable format with other objects of the plug and play client using the Java Runtime package in the PlugMe object. The Server Discovery object 570 searches the web to find potential plug servers, selects one according to its indexing scheme, and contacts the selected server.

The software architecture of the plug server 120 is depicted in FIG. 6. The plug server comprises three servlets: Selection Handler (or Service Inquiry) 610; Login Handler 620; and Subscription Handler 630. Plug server 120 also includes an inspector agent 640 that resides on the web server and communicates with the plug and play client 540 through HTTP. Depending on whether the user is already a subscriber or not, the Selection Handler 610 forwards the plug requests to either the Login Handler 620 or the Subscription Services Handler 630. The Login Handler 620 receives the user ID and password and interacts with the AAA 160 to authenticate the user. Upon successful authentication the Login Handler dispatches the Inspector Agent 640 onto the entity or appliance.

The Subscription Handler 630 receives user's credit card information and verifies it with the credit bureau 190. If verification is successful, the Subscription Handler 630 assigns a user ID (comprising first initial plus last name) and a password (a six digit or less random number in the present embodiment) to the user and dispatches the Inspector Agent 640 onto the appliance.

The Inspector Agent 640 searches the appliance disk, more specifically “/etc/protocols” and “/etc/services” files (in the present embodiment) to determine the needs of the appliance. As already mentioned, the plug and play client 540 contains a security policy file 590 that instructs the appliance to grant necessary permissions to the Inspector Agent 640.

The software inventory 130 in the preferred embodiment of the present invention contains all necessary software and configuration data for providing all network services. However, in the present embodiment, it only contains all necessary software and data for supporting mobility with SIP. This software includes the mobility enabled SIP client, DRCP, Robust Audio Tool (RAT) and Video Conferencing tool (VIC) that are packed into a single tar file.

The plug and play process of the present invention is designed to work in a mobile wireless Internet environment with IPv4 or IPv6 transport that conforms to the network reference architecture (NRA) of the Mobile Wireless Internet Forum (MWIF) or one of its 3GPP or 3GPP2 variants. The process and system are primarily tailored to carrier environments with well-defined heterogeneous functional elements, though it is general enough for use in enterprise, home or ad-hoc networks

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

1. A method for connecting an entity to a network that provides mobile wireless Internet service to a user of the network comprising:
assigning a temporary IP address to the entity;
creating a communication link between the entity and a plug server through the Internet;
identifying the software necessary for the entity to provide the service;
collecting the necessary software from one or more software inventories in communication with the plug server;
forwarding the necessary software from the plug server to the entity; and,
installing and configuring the necessary software at the entity.

2. The method of claim 1 wherein the step of identifying the software necessary for the entity to provide the service further comprises the step of sending an inspector agent from the plug server to the entity capable of discovering the software needs of the entity.

3. The method of claim 1 further comprising the steps of:
collecting information about the identification of the user;
performing authentication of the user's identification prior to the step of identifying the software necessary for the entity to provide the service.

4. The method of claim 1 further comprising the steps of:
securing the communication link between the entity and the plug server using a request for secure HTTP.

5. The method of claim 1 further comprising the steps of:
assigning a new IP address to the entity using DRCP and/or DHCP.

6. The method of claim 2 further comprising the steps of:
sending a request from the inspector agent to the plug server requesting necessary link layer and topology data;
collecting the necessary link layer and topology data from a cell parameter server; and,
forwarding the necessary link layer and topology data to the entity.

7. The method of claim 1 wherein the step of assigning a temporary IP address to the entity further comprises the steps of:
sending a router solicitation message;
receiving a router authentication message and obtaining a network prefix therefrom;
constructing a temporary IP address for the entity; and,
performing duplicate address detection.

8. A system for connecting an entity to a network that provides a mobile wireless Internet service to a user of the network comprising:
a plug server in communication with the entity to be connected;
a software inventory in communication with the plug server for storing software necessary for the entity to provide the service to the user;
a cell parameter server in communication with the plug server for storing link layer and topology data necessary for the entity to provide the service to the user;
wherein the plug server sends an inspector agent to the entity to identify the software needed by the entity to provide the service to the user, collecting the identified necessary information from the software inventory, collecting the necessary link layer and topology data from the cell parameter server and forwarding the collected software and data to the entity.

9. The system of claim 8 further comprising a means for communicating between the plug server and the entity in a secure manner.

10. The system of claim 8 wherein the entity further comprises a server discovery software module for discovering a plug server in the Internet.

11. The system of claim 8 wherein the entity further comprises an Auto-IP software module for assigning a temporary IP address to the entity.

12. The system of claim 8 further comprising an AAA protocol based authentication server in communication with the plug server in order to authenticate information about the identity of the user of the entity.

13. The system of claim 12 further comprising a profile server in communication with the authentication server and the plug server for storing information regarding the identity of entities in the mobile wireless Internet.

14. The method of claim 8 further comprising a credit bureau server in communication with the plug server in order to validate information about the subscription of the user of the entity.

15. A plug server capable of communicating with the Internet and an entity capable of providing Internet services to a user comprising:
a login handler software module for authenticating identification information from the user;
a subscription handler software for validating subscription information from the user;
a selection handler software module for routing the request of the user to either the login handles or subscription handler; and,
an inspector agent software module for identifying the software necessary for the entity to provide the service to the user and for installing the necessary software in the entity.

16. The plug server of claim 15 wherein the login handler communicates with an authentication, authorization and accounting (AAA) protocol based server.

17. The plug server of claim 15 wherein the subscription handler communicates with a credit bureau server.
